(19) United States
(12) Patent Application Publication
(10) Pub. No.: US 2020/0043057 A1
(43) Pub. Date: Feb. 6, 2020

(54) Systems and Methods for Dynamic Advertising Via Distributed Computing

(71) Applicant: Kris Canekeratne, Southborough, MA (US)

(72) Inventors: Kris Canekeratne, Southborough, MA (US); Nalina Sanjaya Wijesundara, Pita Kotte (LK)

(73) Assignee: Kris Canekeratne, Southborough, MA (US)

(21) Appl. No.: 16/052,232

(22) Filed: Aug. 1, 2018

(51) Int. Cl. G06Q 30/02; G09G 3/32; G09G 3/3208; G09G 3/34

(52) U.S. Cl. CPC G06Q 30/0272; G09G 3/32; G09G 2380/02; G09G 3/3208; G09G 3/344; G06Q 30/0252

(57) ABSTRACT

An advertisement or a message is directed to a display device based on: a future time period of an on-going event to be allocated to a person with whom the display device is associated, or an expected viewership of the display device. The future time to be allocated is determined based on the person's prior performance during the on-going event. The expected viewership can be based on one or more of the environment of the display device, and an event expected to occur in that environment. A display device associated with a person may be affixed to an article used by the person. Other display devices may be mounted on movable objects such as vehicles or may be stationary displays.

### FIELD OF THE INVENTION

The invention relates generally to the field of displaying messages in a distributed computing environment, and, more specifically, to systems and methods for dynamic, computer-assisted selection of a message to be displayed on a display device.

### BACKGROUND

Many performers, athletes, contestants on television shows, etc., wear clothing, e.g., tee-shirts, hats, etc., or use other articles such as bags, rackets, etc., to which one or more patches displaying a logo or a slogan that promotes an advertiser's brand, products, or services are affixed. When a performer receives television coverage during the course of his or her performance during an event (e.g., a sports tournament, game show, etc.), the advertisement on the patch on the performer's article, which may be worn or carried by the performer, may be viewed by millions of viewers. For this promotion, the performer usually receives compensation from the advertiser. The more the television coverage the performer receives, thereby increasing the viewers of the advertisement on the patch, the greater the return on the advertiser's investment.

The television coverage received by performers participating in an event is typically highly skewed in that the relatively few performers that outperform the others receive most, if not substantially all of television coverage. Moreover, the performers who have performed well during a completed round/segment of the event are usually scheduled to perform in their next segments during “prime time,” i.e., a time of the day or future date when the live telecast of the event is expected to be watched by a significant number of viewers. The other performers may receive some television coverage, but only during non-prime time when the number of viewers tend to be comparatively small or as a compilation of highlights. Therefore, the return on an advertiser's marketing investment (e.g., the cost of making the advertisement, athlete's compensation, etc.) is maximized when a performer wearing or carrying articles having a display device (e.g., a patch) showing the advertiser's promotional message receives broad prime-time television coverage.

However, it is difficult to predict accurately how one performer will perform during a certain event and, accordingly, when and how much television coverage he or she will receive. Therefore, advertisers or sponsors typically negotiate the advertising contracts with performers, for example, athletes based on their rankings or overall standings in the sport, in the hope that the better-ranked athletes will perform as predicted and receive substantial television coverage during prime time. While seedings and rankings may be a good predictor of which athletes will be performing on the last day of a tournament, upsets often occur and an individual may receive significantly more exposure than anticipated. As such, seedings and rankings, which are almost always based on the athletes' performance in previous sports events, cannot accurately indicate how much television coverage any one athlete (and a performer, in general) would receive, and the time of the day of that coverage, during an on-going event.

Therefore, conventional approaches impose several limitations on both the advertisers or sponsors and the performers. For example, an advertiser having a contract with an athlete may not receive a high return on investment if the athlete under the contract does not get substantial television coverage. In addition, the advertiser may not have a contract with another athlete who would get broad coverage during the next segment of the sports event to which he or she unexpectedly progressed. Therefore, the advertiser may not be able to promote its products and/or services during the live broadcast of the event using a patch worn or carried on articles by that athlete or, in general, a performer participating in an on-going event. Also, should a low-ranked athlete receive broad television coverage, he or she, due to a lack of prior knowledge of such coverage, may not have a contractual agreement to wear advertisements on clothing or display them on his or her articles, and thus, may miss out on potential compensation. Therefore, there is a need for improved methods and systems that enable dynamic selection of advertisements for display on advertising devices.

### SUMMARY OF THE INVENTION

In various embodiments of the present invention, an advertiser and/or its advertisements are dynamically matched with a display device associated with an article associated with a person, such as clothing worn or equipment used by the person, so as to improve the advertiser's return on investment, and/or to provide commensurate compensation to the person for the promotion. This is achieved, in part, by considering the person's (e.g., an athlete's) performance during a completed segment of an on-going event, such as a round in a golf or tennis tournament in progress. Based on that performance, the television coverage allocated to the person during a future segment of that on-going event, e.g., the next round, may increase or decrease. Then, according to the television coverage to be allocated to the person, advertisements from different advertisers are selected to be displayed during the future segment of the event on a display device associated with the person.

In this way, the advertisements and display devices are not matched before the event but are matched during the course of the event, based on the person's up-to-date performance, which is often directly related to the television coverage to be allocated to that person. Furthermore, the above-described matching is dynamic, i.e., it can change from one segment of the on-going event to another. For example, an advertisement may be selected for display on a display device associated with one person during one segment, but on a display device associated with a different person during another segment. Likewise, the same advertisement may be placed on different devices, either associated with the same person or different people.

Dynamically selecting the display device associated with an article associated with the person who is to be allocated maximum television coverage and/or coverage during prime time increases the likelihood that the advertisement on that display device is viewed by a large number of viewers, thereby increasing the return on investment for the advertiser. Furthermore, because the advertisements are selected to be displayed on a display device associated with a person based on the knowledge of the television-coverage time to be allocated to that person, he or she can demand compensation commensurate with the promotion he or she can provide during the future segment of the event.

Wearable display technology makes it feasible to select and adjust a message to be displayed dynamically, based on real-time or near-real-time information, e.g., information that is only a few seconds, minutes, or hours old). It is usually desirable that a wearable display devices be thin (e.g., less than 1 inch thick, only a few millimeters thick, etc.), flexible, light weigh (e.g., weigh less than 5, 2, or 1 ounce(s), etc.), and consuming as little power as possible. The athletes and performance may not want to wear big bulky devices and large batteries. As such, many wearable display devices lack computing power. For example, they do not include a processor or even an application specific integrated circuit (ASIC) customized to perform computations, because processors and ASIC consume power and, as such, may need additional batteries. Therefore, the selection of a message to be displayed on a display device worn by a person may be performed at a computer located remotely from the display device. That computer may then transmit the selected message (or a message identifier) directly to the display device and/or via one or more intermediate transceivers.

Accordingly, in one aspect, a computer-implemented method of selecting a message (e.g., an advertisement) for display on an article associated with a person includes determining a future time period of an on-going event to be allocated to the person based on a level of the person's prior performance during the on-going event. The future time period is associated with a quality metric, where the quality metric includes one or more of: (i) a length of the future time period, and (ii) an expected viewership associated with the future time period. The level is selected from two or more levels, e.g., from at least a first level and a second level, where the second level represents a lower performance than performance associated with the first level. As such, the quality metric for the future time period corresponding to the first level is greater than the quality metric for the future time period corresponding to the second level. The method also includes selecting, based on the allocated future time period, a first message (e.g., an advertisement) for display on the article associated with the person using a first display device associated with the article. The selection is performed by a processor that is in communication with but located remotely from the first display device. The person maybe an athlete, a talent performer (e.g., a singer, musician, etc.), or a contestant on a show such as a quiz show or a game show.

In some embodiments, the on-going event includes a sports tournament, and the level of the person's prior performance during the sports tournament may include a ranking among other participants (i.e., athletes) in the sports tournament. The on-going event can also be a show, such as a quiz-show, a talent show, and/or a reality show. The future time period may include a broadcast time period during which the person's future performance in the on-going event (e.g., performance in the next round, etc.) is to be broadcast.

In some embodiments, the first display device is affixable to the article, and the article may include an article that is worn by the person such as a shirt, a hat, pants, or shoes. The article may also include an equipment used by the person, such as an arm band, a helmet, a bag, a glove, a racket, a bat, and a stick.

In some embodiments, the first message includes a first advertisement and the selection the first message includes computation performed by the processor for each of several candidate advertisements, a corresponding advertisement metric that is based on one or more parameters of the respective candidate advertisements. The computation of the advertisement metric for each candidate advertisement is also based on the future time period. Moreover, the method includes designation as the first advertisement the candidate advertisement having a maximum advertisement metric.

A parameter of the candidate advertisements can be a required display time such that if the future time period is smaller than the required display time, that candidate advertisement cannot be selected by the processor. Another parameter may be a compensation for display, so that if the required display time of two or more candidate advertisements is less than the future time period, the candidate advertisement for which maximum compensation is offered may be selected.

In some embodiments, the method includes determining a compensation for the person for displaying the first advertisement during the future time period. The determination of the compensation may include the determination of a base compensation, and adjusting the base compensation based on the level of the person's performance during the future time period.

The first advertisement may be selected by auctioning the future time period among several advertisers, and by designating an advertisement from an auction-winning advertiser as the first advertisement. For example, the advertiser willing to pay maximum compensation can be the auction winner. The method may also include downloading the first advertisement to the first display device.

In some embodiments, a second message for display using a second display device may be selected based on the future time period. The second display device may be associated with either the article with which the first device is associated, or another article associated with the person. For example, one display device may be affixed to the person's hat while the other one may be located on the person's bag.

In the alternative, the method includes displaying the second message using the first display device, and apportioning a first display interval of the first message and a second display interval of the second message between the future time period. Thus, during the entire future time period, one message (e.g., an advertisement) is displayed during a first interval, and a second message is displayed during the second interval. The method may also include selecting a start time of the first display interval.

In another aspect, a system for maximizing the utilization of display devices affixed to articles associated with persons includes a processor configured to select from several messages, based on a future time period of an on-going event, where the future time period is to be allocated to a person, a first message for display on a first display device affixed to an article associated with the person. The processor may be located remotely from the first display device. The system also includes a communication module to transmit the first message (e.g., an advertisement) to the first display device. A compensation to the person for displaying of any message selected from the several messages on the first display device is, at least in part, proportional to one or more of: (i) a length of the future time period and (ii) an expected viewership of the future time period. The message that is associated with maximized compensation for the allocated future time period is selected as the first message. The person maybe an athlete, a talent performer (e.g., a singer, musician, etc.), or a contestant on a show such as a quiz show or a game show.

In some embodiments, the processor is configured to determine the future time period of the on-going event to be allocated to the person based on the level of the person's prior performance during the on-going event. The communication module may be configured to receive the level of the person's prior performance during the on-going event. The article to which the first display device may be affixed may include an article that is worn by the person such as a shirt, a hat, pants, or shoes. The article may also include an equipment used by the person, such as an arm band, a helmet, a bag, a glove, a racket, a bat, and a stick.

In some embodiments, the first display device includes a wireless receiver module for receiving the first advertisement, and a display panel for displaying the first advertisement. The display panel may include one or more of a light-emitting diodes (LEDs) based display, and organic LEDs (OLEDs) based display, and an e-ink based display. The communication module may include a transmitter in electrical communication with the processor, and a remotely disposed controller in electrical communication with the transmitter and the first display device. The controller may receive an advertisement/message from the transmitter and may forward it to the display device.

The on-going event may include a sports tournament, and the level of the person's prior performance during the sports tournament may include a ranking among other participants (i.e., athletes) in the sports tournament. The on-going event can also be a show, such as a quiz-show, a talent show, and/or a reality show. The future time period may include a broadcast time period during which the person's future performance in the on-going event (e.g., performance in the next round, etc.) is to be broadcast.

In some embodiments, the communication module is configured to receive candidate advertisements from which the first message (e.g., an advertisement) is selected. The system may include a first database of persons. For each person in the first database, a first article is associated with that person, and a respective first display device is associated with the respective first article associated with that person. Additionally or in the alternative, the system may include second database of candidate advertisements, from which the first message is selected.

The processor may be configured to compute, for each of several candidate advertisements, a corresponding compensation that is based on at least in part one or more parameters of the respective candidate advertisements. The computation of the compensation is also based on a characteristic of the future time period, e.g., the length or the expected viewership of the future time period. Moreover, the processor may designate as the first advertisement the candidate advertisement having a maximum compensation.

A parameter of the candidate advertisements can be a required display time such that if the future time period is smaller than the required display time, that candidate advertisement cannot be selected by the processor. Additionally or in the alternative, a parameter of the candidate advertisements can be a required expected viewership such that, if the expected viewership of the future time period is smaller than the required expected viewership, that candidate advertisement cannot be selected by the processor. Another parameter may be an offered compensation for display, so that if the required display time of two or more candidate advertisements is less than the future time period, the candidate advertisement for which maximum compensation is offered may be selected.

In some embodiments, the processor is configured to determine a compensation for the person for displaying the first message during the future time period. The determination of the compensation may include the determination of a base compensation, and adjusting the base compensation based on the person's performance during the future time period.

The communication module may be configured to receive bids based on the future time period from a number of advertisers, and the processor may be configured to select an advertiser by comparing the received bids, and to designate an advertisement from the selected advertiser as the first message. The communication module may be configured to download the first message to the first display device.

In some embodiments, the processor may select, based on the future time period, a second message for display using a second display device. The second display device may be associated with either the article with which the first device is associated, or another article associated with the person. For example, one display device may be affixed to the person's hat while the other one may be located on the person's bag.

In the alternative, the second message may be displayed using the first display device, and the processor may be configured to apportion a first display interval of the first advertisement and a second display interval of the second advertisement between the future time period. Thus, during the entire future time period, one advertisement is displayed during a first interval, and a second advertisement is displayed during the second interval. The processor may also select a start time of the first display interval.

In another aspect, a display device affixable to an article associated with a person, for displaying advertisements and/or messages, includes a processor to either receive or determine a future time period of an on-going event to be allocated to the person based on the person's prior performance during the on-going event. The processor is also configured to select, based on the future time period, a first message/advertisement. The display device also includes a display panel for displaying the first message/advertisement. The display panel may include light-emitting diodes. The person maybe an athlete, a talent performer (e.g., a singer, musician, etc.), or a contestant on a show such as a quiz show or a game show.

In some embodiments, the display device includes a receiver module for receiving the person's prior performance during the on-going event. The receiver module may also be configured to receive candidate advertisements from which the first message/advertisement is selected. Alternatively, or in addition, the display device may include a database of candidate advertisements, from which the first message/advertisement is selected. In some embodiments, the receiver is configured to receive bids based on the future time period from several advertisers, and the processor is configured to select an advertiser by comparing the received bids, and to designate an advertisement from the selected advertiser as the first message/advertisement. The receiver module may include a wireless receiver.

The on-going event may include a sports tournament, and the person's prior performance during the sports tournament may include a ranking among other participants in the sports tournament. The on-going event can also be a show, such as a quiz-show, a talent show, and/or a reality show. The future time period may include a broadcast time period during which the person's future performance in the on-going event is to be broadcast.

In some embodiments, the processor is configured to compute, for each one of several candidate advertisements, a corresponding advertisement metric that is based on one or more parameters of the respective candidate advertisements and the future time period. The processor is also configured to designate as the first message/advertisement the candidate advertisement having a maximum advertisement metric.

A parameter of the candidate advertisements can be a required display time such that if the future time period is smaller than the required display time, that candidate advertisement cannot be selected by the processor. Another parameter may be a compensation for display, so that if the required display time of two or more candidate advertisements is less than the future time period, the candidate advertisement for which maximum compensation is offered may be selected.

In some embodiments, the processor is configured to determine a compensation for the person for displaying the first message/advertisement during the future time period. The determination of the compensation may include the determination of a base compensation, and determining the compensation by adjusting the base compensation based on the person's performance during the future time period.

In some embodiments, the processor is configured to select, based on the future time period, a second message/advertisement for display using the display panel. The processor is also configured to apportion a first display interval of the first message/advertisement and a second display interval of the second message/advertisement between the future time period. The processor may also select a start time of the first display interval.

In another aspect, a computer-implemented method is provided for selecting a message for display on a display unit. The method includes: determining by a processor an expected viewership of the message, based on a parameter associated with the display unit, and selecting by the processor, based at least in part on the expected viewership, a message for display on the display unit. In some embodiments, the display unit is associated with a movable object, and the parameter associated with the display unit includes one or more of: a location of the object, an average speed of movement of the object, a time of a day, weather associated with the movable object, and a distance of the movable object from a landmark.

The movable object may be a taxi or a bus, and the location of the object may be classified as uncrowded or crowded. The average speed of movement of the object may be classified as slow or fast, and the expected viewership may: (i) designated to be greater for a crowded location than for an uncrowded location, and/or (ii) designated to be greater for a slow speed than for a fast speed.

In some embodiments, the display unit is affixed in a location, and the parameter associated with the display unit may include a difference between a time selected for displaying the message and a time of an event expected to occur at the location. The location may include a public transportation venue, and the expected event may be an expected arrival or departure of a transport vessel. The expected viewership may include: a first value associated with a first difference between the time selected for displaying the message and the time of expected arrival and departure, and a second value associated with a second difference between the time selected for displaying the message and the time of expected arrival and departure. The second difference may be smaller than the first difference and, accordingly, the second value may be greater than the first value.

The display unit may be affixed in a public transportation venue. The parameter associated with the display unit may include: (i) a location from which a transport vessel is scheduled to arrive at the public transportation venue, and/or (i) a destination location of the transport vessel. Alternatively or in addition, the parameter associated with the display unit may include an estimated size of crowd at the location. The method may also include estimating the size of crowd by counting a number of persons in an image obtained using a camera, and/or by counting in an image obtained from a camera a number of eye-balls directed to the camera. In some embodiments, selecting the message is further based at least in part on one or more of a bid price associated with the message and an ask price.

In another aspect, a system that includes a processor is provided for selecting a message for display on a display unit. The processor is programmed to determine an expected viewership of the message, based on a parameter associated with the display unit, and to select, based at least in part on the expected viewership, a message for display on the display unit. In various embodiments, the system may be configured to and/or the processor may be programmed to perform one or more operations according to the method described above.

In another aspect, a display device includes a display panel for displaying a first message. The display panel is affixable to an article associated with a person, such as clothing, hat, bag, racket, etc. The display device also includes a receiver module for receiving wirelessly a first signal to display a first message. The first message is selected from a number of messages based on, at least in part, a future time period of an on-going event to be allocated to the person based on the person's prior performance during the on-going event. The first signal can be an identifier of the first message or the first message itself. The receiver module may be configured for receiving wirelessly a second signal to display a second message. The second message may also be selected from the several messages based on, at least in part, the future time period of the on-going event to be allocated to the person based on the person's prior performance during the on-going event.

The display panel may include light-emitting diodes. Alternatively, or in addition, the display panel may be flexible and/or wearable. The receiver module may be configured to receive candidate messages from which the first message is selected upon receiving the first signal. The candidate message may be stored in a volatile or non-volatile storage optionally included in the display device. In some embodiments, the on-going event includes a sports tournament or a talent show or competition. The person's prior performance during a sports tournament may include a ranking among other participants in the sports tournament. The future time period may include a broadcast time period during which the person's future performance in the on-going event is to be broadcast.

Other aspects and advantages of the invention will become apparent from the following drawings, detailed description, and claims, all of which illustrate the principles of the invention, by way of example only.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a process of matching/selecting advertisements for display using a display device associated with a performer, according to an embodiment of the invention.

FIG. 2 illustrates a process of adjusting the compensation of a performer based on the performer's performance in an on-going event, according to an embodiment of the invention.

FIG. 3 illustrates a process allowing various advertisers to bid for displaying their advertisements using a display device associated with a performer, according to an embodiment of the invention.

FIG. 4 schematically shows a system for selecting or matching advertisements for display using a display device associated with a performer, a movable object, or a stationary object, according to various embodiments of the invention.

FIG. 5 depicts various display devices associated with a performer, according to an embodiment of the invention.

### DETAILED DESCRIPTION

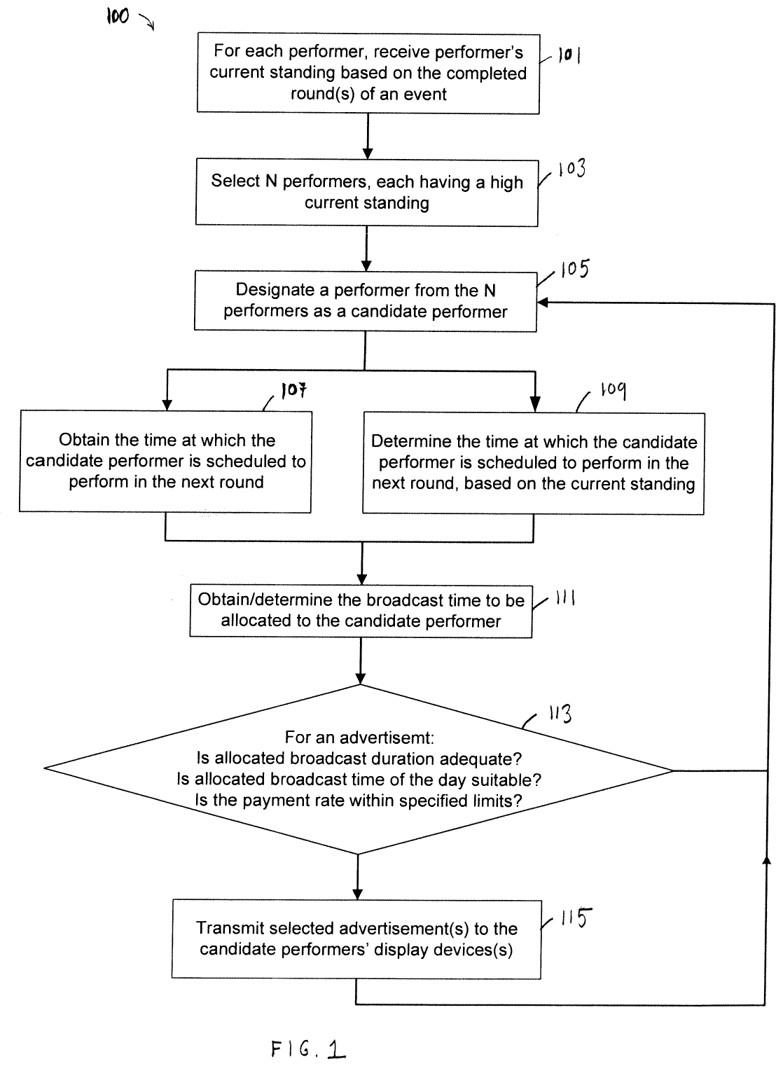

Referring to FIG. 1, in a process 100 for matching advertisements with display devices associated with one or more performers, in step 101, for each performer (e.g., an athlete such as a golfer, tennis player, swimmer, bicyclist, or race-car driver, or a contestant in a television game show, talent show, or reality show, etc.) participating in an on-going event, the performer's current standing in the on-going event is obtained. This standing is based only on the performer's performance during the completed rounds or segments of that event. For example, in a golf tournament, the golfer's rank at cut off, which is based only on the pre-cut-off rounds and not on the golfer's overall ranking, is considered in determining the current standing of the golfer. Similarly, in a talent competition, the votes received by the performer based on his or her performance during the completed portions of the competition may be considered in determining the current standing of the performer.

Based on the performers' current standing, a certain number of performers (denoted as N) are selected in step 103, each of the N performers having a better current standing than the unselected performers. For example, in a tennis tournament, the eight tennis players who have advanced to the quarter-final round may be selected after the round immediately preceding the quarter-final round. This is because the remaining participants will not play in the quarter-final and subsequent rounds, and hence, will not receive significant television broadcast coverage during those rounds. In various embodiments, N can be as small as one, or may be as large as the total number of participants in the on-going event. In step 105, one of the N selected performers is designated as a candidate performer.

In step 107, for the candidate performer, the day and time at which that performer is scheduled to perform in the next round/segment of the on-going event is obtained. For example, a quarter-finalist of a tennis tournament may be scheduled to play on a Saturday morning, while another quarter finalist may be scheduled to play during the afternoon on that Saturday. Similarly, all three winners from the previously completed rounds of a quiz show may be scheduled to compete with one another on a Sunday evening. The day/time information for the candidate performer may be supplied to a processor or, in the alternative, such information may be computed by the processor in step 109. In some embodiments, this computation may include receiving the event schedule and identifying the performance time to be allocated to the candidate performer using the performer's name and/or current standing in the on-going event.

Based on the day and time of the day at which the candidate performer is scheduled to perform in the next round, a television broadcast time that performer may receive is determined in step 111. For example, in one instance, an athlete may be scheduled to play between 9 AM and 12 PM on a Saturday, but live television coverage of that sports event may only be provided between 11 AM and 12 PM. In another instance, live television coverage may be provided during the entire duration of the next round of a talent show, but the broadcast time may be substantially evenly divided between the three contestants scheduled to compete during that round. Therefore, each individual performer may receive only about one third of the total duration of the live broadcast coverage.

Once the broadcast time to be allocated to the candidate performer is determined, advertisement messages such as logos or slogans from one or more advertisers may be paired with the display devices associated with that candidate performer, in step 113. The pairing is based, in part, on the broadcast time to be allocated, the requirements for each advertisement, and/or requirements of the performer.

For example, a certain logo may be displayed only if the broadcast time to be allocated to the candidate performer is greater than a certain duration, e.g., more than half hour, two hours, etc. Additionally, or in the alternative, a certain advertisement may be displayed only if the broadcast time to be allocated to the candidate performer falls during on a certain day and/or during a certain time of the day. To illustrate, a particular advertiser may wish to display its messages only on Saturday and Sunday evenings during 6 and 8 PM. A likely reason for such a requirement is that the viewership may be significantly greater during those days/times compared to other times, taking advantage of which, the advertiser may wish to increase the return on investment on the cost of advertising. As such, only the performers scheduled to perform and would thus receive broadcast coverage on Saturday and Sunday between 6 and 8 PM may be selected to display that particular advertiser's advertisement messages.

The pairing of advertisements to the candidate performer's display devices can also be based, in part, on other parameters that may be considered at step 113, such as whether a maximum payment a certain advertiser would pay during the on-going event meets or exceeds the remuneration requirement of the performer who would display the advertisement. The matching at step 113 may also consider whether a performer who meets the requirements of a new vendor is under a contractual obligation with another vendor, a competitor of the new vendor, or an event sponsor, not to display advertisements from competitors or other vendors. In those circumstances, another one of the N selected performers may be considered to display advertisements from the new vendor.

Once an advertisement is paired with a display device associated with the candidate performer, that advertisement is transmitted to the corresponding display device in step 115. Then, the steps 105-113 are repeated so as to select advertisements for display using the display devices associated with the remaining of the N performers selected in step 103. In some embodiments, the steps of matching advertisements with display devices (i.e., steps 105-113) are completed for each of the N selected performers, and then the selected advertisements are transmitted to the corresponding display devices.

In some embodiments, more than one display devices may be associated with one or more of the N selected performers. For example, one display device may be attached to a tee-shirt worn by a performer, and another display device may be attached to a bag carried by the performer. Accordingly, in step 113, the same advertisement (e.g., a logo) may be selected for display on both the tee-shirt and the bag, or two different advertisements may be selected for display on the two display devices on the tee-shirt and the bag, respectively. The two advertisements may be provided by the same or different advertisers.

In some embodiments, two different advertisements from the same or different advertisers/sponsors may be selected to be displayed on a single display device associated with a performer, in step 113. The first advertisement may be displayed during one portion of the total broadcast time to be allocated to the performer as described in step 111. For example, if an athlete is scheduled to play from about 6 PM to 8 PM on a Saturday, a logo for one type of soda sold by a sponsor may be displayed on a display device on the athlete's hat between about 6 and 7 PM, and a logo for another type of soda, also sold by the same sponsor, may be displayed on the athlete's hat between about 7 PM and 8 PM. Alternatively, an advertisement from a different sponsor for a different product (e.g., a shoe) may be displayed on the athlete's hat between about 7 and 8 PM.

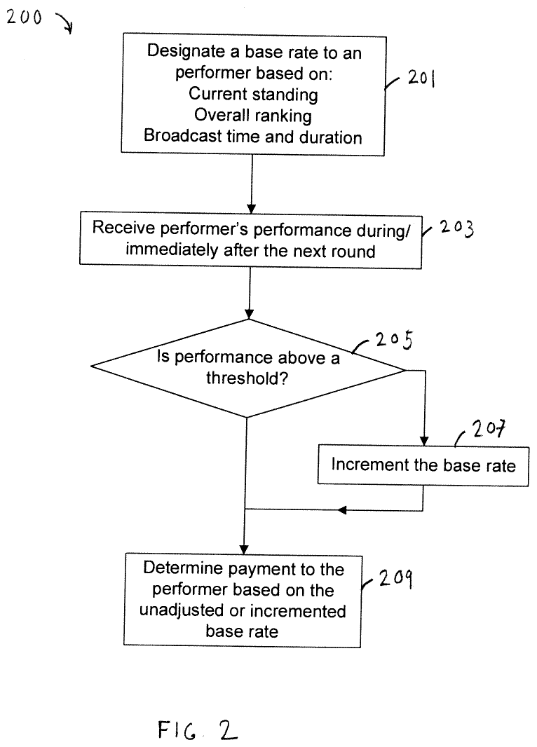

Referring to FIG. 2, in a process 200 for computing a performer's compensation for displaying advertisements, a base rate is designated to the performer in step 201. The base rate may be based on, in part, the performer's current standing in the on-going event. For example, if the performer is an athlete participating in a sport event, the athlete's overall ranking or seeding in the sport may be considered in determining the base rate for that athlete. The base rate for a performer may also be based on, in part, the broadcast time to be allocated to the performer, and/or the duration of the broadcast. For example, a highly ranked athlete who has outperformed the other participants during the completed portion of the on-going tournament may receive a higher base rate compared to an unranked athlete who has received a high current standing.

In step 203, information regarding the performers's performance in the next round, once that round is in progress and/or has ended, is obtained. Whether the performer continues to outperform many other participants is determined in step 205, for example, by comparing the next-round performance with a certain threshold level. To illustrate, if the athlete were ranked among the top five participants immediately before the commencement of the next round, a performance threshold may require the athlete to maintain that ranking at the end of the next round, or, in some embodiments, the threshold may require that the athlete not fall outside the top-ten players at the end of the next round.

If the performer meets or exceeds such a threshold, the performer may receive a bonus, i.e., the performer's base rate may be incremented in step 207. In some embodiments, the performer's base rate may be decreased if the performer's performance in the next round falls below a required threshold. In step 209, the total payment to the performer is determined, in part, by the initial or updated base rate, and the total broadcast time to be allocated and/or actually received by the performer.

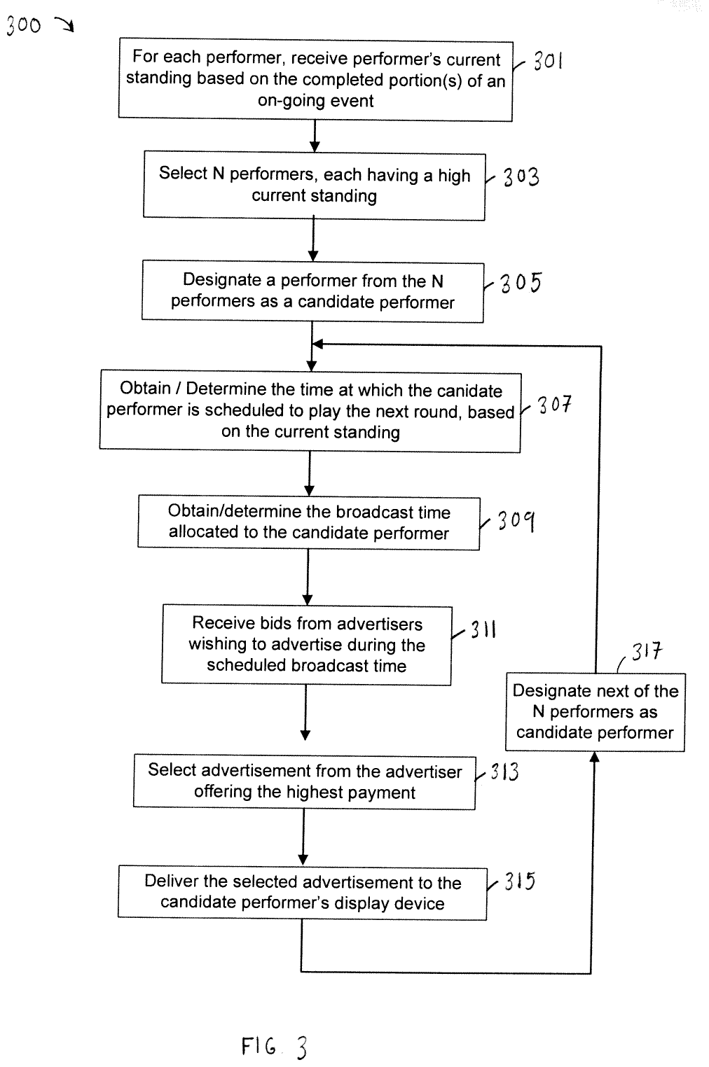

Referring to FIG. 3, in a bidding process 300, for each performer participating in an on-going event, that performer's current standing based on the completed portion of the event is received in step 301. The top N performers are selected in step 303, such that each of the selected performers has outperformed, i.e., has obtained a better standing than the other participants in the on-going event during the completed portion or portions of that event. One of the top N performers is designated as a candidate performer in step 305. The day and time of the day at which the candidate performer is scheduled to perform in the next round is obtained or determined in step 307. The day and time of the day may be based, in part, on the candidate performer's current standing. Based on the day and time at which the candidate performer is scheduled to perform in the next round/segment of the on-going event, a television broadcast time period to be allocated to the candidate performer while he or she performs in the next round/segment is obtained or determined in step 309. The steps 301-309 are similar to the steps 101-111 described above with reference to FIG. 1.

In step 311, bids are received from several advertisers/sponsors wishing to display their message (e.g., a logo, a slogan, etc.) during the broadcast time to be allocated to the candidate performer. The bid may include various parameters such as a preferred time of the day of the broadcast, preferred athletes or contestants, etc. The bid offering the highest payment among the received bids is selected in step 313. Any other parameters specified in the bid may also be considered during the selection step 313. The advertisement corresponding to the selected bid is transmitted to a display device associated with the candidate performer in step 315, and the steps 307-315 may be repeated after designating another one of the top N performers as the candidate performer, in step 317.

A performer designated as a candidate performer in the steps 305, 317 may have more than one display devices associated with him or her. Accordingly, as described above with reference to FIG. 1, an advertisement corresponding to the winning bid may be displayed using all display devices associated with that candidate performer, or different bids may be selected for that performer, and different advertisements may be displayed using the different display devices associated with that performer. Moreover, one display device may be configured to display two or more advertisements corresponding to different bids during different portions of the total broadcast period to be allocated to the candidate performer.

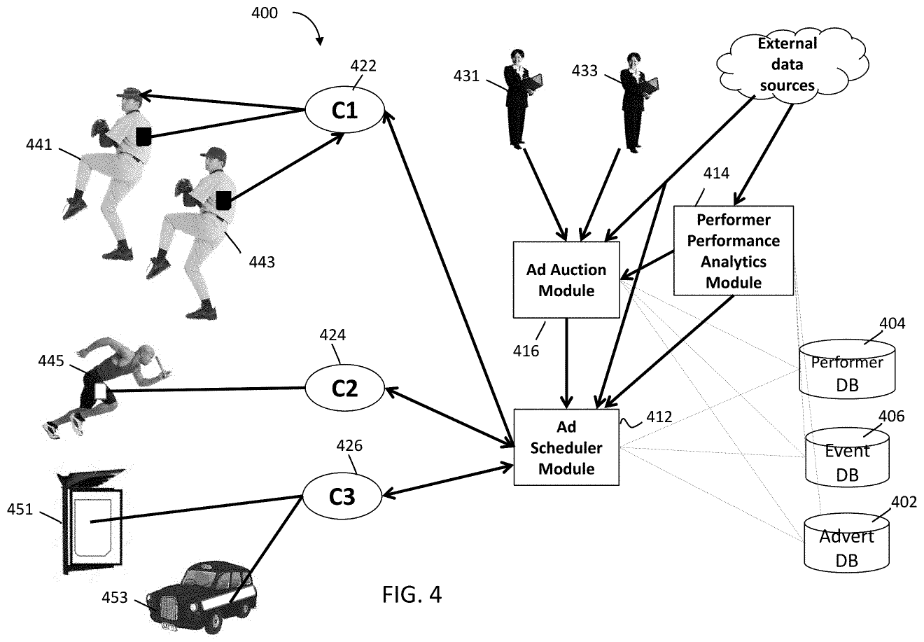

A system 400, shown in FIG. 4, that can implement the above-described processes includes a database of advertisements 402. The advertisements database 402 may include the text and/graphics of an advertisement, information about the advertiser, and other parameters such as the required broadcast duration and/or time, a payment rate, etc. The advertisement database 402 is a logical entity that may be distributed across several physical databases, each of which may reside on the same or different computers or servers.

The system 400 also includes a database of performers 404 that may include information such as the performer's required payment rate, and/or current standing based on the completed portion of an on-going event. For athletes, the database 404 may include an athlete's overall ranking/seeding in his or her sport. For other and/or athlete performers, the database 404 may include a popularity index of the performer. Information such as the day and time of the day the performer is scheduled to play the next round/segment of the on-going event and the broadcast time to be allocated to the performer may also be stored in the database 404. The database of events 406 can store information about various events such as sports tournaments and television game shows. The information stored in the database 406 may include, for example, play schedules, contest schedules, and broadcast schedules, that can be used to determine the broadcast time to be allocated to a performer. Each of the performers database 404 and the events database 406 is also a logical entity, that may be distributed across several physical databases, each of which may reside on the same or different computers or servers.

The advertisement scheduler module 412 matches advertisements to one or more display devices associated with one or more performers 441, 443, 445, as generally described above with reference FIG. 1. In order to facilitate one or more of the advertisement matching operations, the advertisement scheduler module 412 can obtain performer analytics from a performer performance analytics module 414. The analytics information may include, e.g., a player's standing, ranking, the broadcast time a performer has already received, etc. The performer performance analytics module 414 may update a rate at which compensation is to be paid to a performer and/or the total compensation, e.g., as described earlier with reference to FIG. 2.

An advertisement auction module 416 may receive bids from several advertisers/vendors (e.g., vendors 431, 433), and may allocate a particular time slot to a selected advertiser for displaying that advertiser's message on the display device associated with a selected performer. To this end, the advertisement auction module 416 generally performs the operations described with reference to FIG. 3. The advertisement auction module 416 may also select the message to be displayed and/or the particular performer, and may perform these operations independently or in coordination with the advertisement scheduler module 412 and/or the performer performance analytics module 414.

One or more of the modules 412-416 can be used to update the information about the advertisements, performers, and events in the databases 402, 404, 406, respectively. Any of these modules can obtain information from one or more external data sources about events, broadcast schedules, one or more vendors/advertisers 431, 433 and/or one or more performers 441, 443, 445. In some embodiments, the external source can be a website that vendors/advertisers and/or performers can access to update their own information, such as ranking/seeding, contractual obligations, minimum required compensation, etc. Although FIG. 4 shows only two vendors/advertisers and three performers, it should be understood that this is illustrative only and that system 400 may interact with fewer or more vendors/advertisers and/or fewer or more performers.

In some embodiments, a controller 426 is in communication with a stationary display device 451 mounted in a certain location such as a train platform, a boarding gate at an airport, etc. Alternatively, or in addition, the controller 426 may be in communication with a display device affixed to a movable object, such as a taxi 453, a bus, etc. The selection and delivery of advertisements and messages to be displayed on these displays that are stationary or affixed to movable objects are discussed below.

In some embodiments, the advertisement scheduler module 412 provides information about a selected advertisement, such as text of the message and/or graphics of a logo, and/or an identifier of such a message and/or logo, and/or the display device upon which the selected advertisement is to be displayed to a selected controller (e.g., controller 422, 424, or 426), which then transmits the advertisement information (advertising content) to the selected display device. The scheduler module 412 may also send several messages, the display devices on which those messages are to be displayed, and schedule(s) for each display device to the controllers. The controllers 422, 424 may be in communication with the module 412 via a wired connection or a wireless connection, and the controllers generally communicate with the display devices via a wireless connection.

In some embodiments, a display device associated with a performer (e.g., the player 431) includes one or more sensors, such as a heart-beat monitor, a light intensity sensor, a direction sensor, etc. A controller (e.g., the controller 422) may be configured to receive and forward one or more sensor signals to the advertisement scheduler module 412, which may then analyze the forwarded sensor signals and take further action. For example, if a hear-beat is not received from a particular performer (e.g., the player 431), this information may be used to determine that the display device associated with that performer (e.g., the player 431) is unable to communicate with a particular controller (e.g., the controller 422) and, as such, the scheduler 412 may attempt communication with the performer 431 via another controller. Information such as the intensity of light sensed by the sensor and/or the orientation of the display device may be used to adjust the intensity, color, and/or polarization of the display device. In some embodiments, the controller itself may be configured to perform such adjustments.

In general, the controllers 422, 424 are installed in an arena in which a performer performs, such as a sports stadium or arena, a golf course, an auditorium where a competition (such as a singing competition, a cooking competition, etc.) is held. One or more controllers can be provided as a cloud-computing service, however. Depending on the size of the arena and/or the number of performers, only one or more than two (e.g., 5, 10, 30, etc.) controllers may be provided and one or more of these controllers can wirelessly communicate with one or more display devices associated with one or more performers. The modules 412-416 are typically provided by one or more servers.

In some embodiments, the advertisement scheduler module 412 can directly communicate with one or more displays and the controllers may not be used. In some embodiments, the display device includes a processor that is programmed to provide the functionality of one or more of the modules 412-416, and a memory module. As such, one or more of the modules 412-416 and/or controllers 422, 424 may not be included in some embodiments.

In some cases, a controller (e.g., the controller 424) receives only the time slot, an identifier of a selected display, and an identifier of a message to be displayed and/or an advertiser identifier from the advertisement scheduler module 412. In response, the controller 424 communicates with the corresponding advertiser, receives the message to be displayed, and passes on that information to the selected display. In some other cases, a selected display includes a transceiver, and receives the time slot and an identifier of a message to be displayed and/or an advertiser identifier, from the advertisement scheduler module 412. In response, the selected display communicates with the corresponding advertiser, receives the message to be displayed, and displays that message. In both cases, the received message may include text and/or graphics.

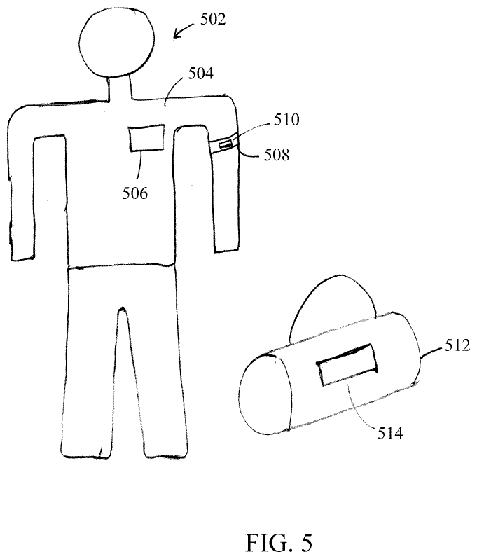

As depicted in FIG. 5, a performer 502, such as an athlete, a talent performer (e.g., a singer, musician, etc.), or a contestant on a show (e.g., a quiz show or a game show), may wear a tee-shirt 504 to which a display device 506 is attached. The performer 502 may also wear an arm band 508 to which another display device 510 is attached. The performer 502 may carry a bag 512, to carry his or her sports gear, etc., to which yet another display device 514 is attached. The display devices 506, 510, 514 are thus associated with the performer 502. As described above with reference to FIGS. 1-3, each of these display devices 506, 510, 514 may display the same or different advertisements. Moreover, one or more of the display devices 506, 510, 514 may display one advertisement during one portion of the broadcast time to be allocated to the performer 502, and another advertisement during another portion of the broadcast time to be allocated to the performer 502. It should be understood that in various embodiments, fewer or more than three display devices may be associated with a performer.

In various embodiments, a display device associated with a performer is a low power, wearable device that is thin enough to adhere to the performer's equipment and/or garments without significantly (e.g., by more than 0.5%, 1%, 2%, 5%, 10%, etc.) altering the weight and balance of the equipment and/or garment. The display device is flexible enough so that it can be sewn on, pasted on, printed on, etc., to an article of clothing such as a sports jersey or an accessory such as a baseball cap. Moreover, a display device adhered to a garment should withstand hot, humid, and/or sweaty conditions that typically exist during a sports event. A device affixed to a sports equipment such as a cricket bat or protective gear such as a helmet should be able to withstand strong vibrations, if not direct forces, such as due to an impact with a ball, another helmet, etc.

The display device may be used in an indoor environment, such as a basketball or ice hockey arena, or in an outdoor environment, such as a golf course, a football, soccer, or cricket stadium. In an indoor environment, the display device would be exposed to strong lights and it may be exposed to sunlight in an outdoor environment. The displayed content should be clearly visible to spectators as well as on television and/or via Internet broadcast or simulcast. The display device should also be able to communicate wirelessly, to receive content and/or content reconfiguration or selection commands. In some cases, it is desirable for the display device to transmit data to a remote receiver.

Organic light emitting diode (OLED) based displays and E-Ink based displays can meet one or more of the requirements discussed above. For example, in some embodiments an OLED display provides a contrast greater than 1,000:1 (which is typically the contrast of an liquid crystal display (LCD)), e.g., contrasts of approximately 3,000:1; 10,000:1; 250,000:0; 1,000,000:1, etc. In some embodiments, the OLED display offers color gamut of approximately 60%, 75%, 90%, 100%, 105%, 107%, etc., for an NTSC system (used in the U.S.), and an average luminance of approximately 50, 75, 100, 120, 150, 200, etc. cd/m², with a peak luminance of approximately 100, 150, 300, 400, 600 cd/m², etc. In some embodiments, the resolution (i.e., the pixel size) of the OLED display is approximately 4.7×4.7; 5×5; 7×7; 10×10; 12×12; 15×15 μm. In various embodiments, the power requirement of the OLED displays ranges from 2 V up to 10 V, and the thickness can approximately be 0.01; 0.015; 0.002; 0.004; 0.008 mm, etc. The bending radius can be approximately 0.2; 0.4; 0.5; 1.0; 1.25; 1.6; 2.0 mm, etc.

In some embodiments, an E-ink display includes plasmonic metasurfaces (also called cells) that can be turned on and off by a change in the voltage applied to individual cells. The cells actually do not emit any light; instead they selectively reflect incident light. As such, embodiments of E-ink displays are well suited for outdoor environments where they may be exposed to bright sunlight. The power consumption of various embodiments of E-ink displays is generally less than that of OLED displays. The power consumption of an E-Ink display of size 1.5 to 2.5 cm² is approximately 25-50 mW, and the power consumption of an OLED display of a similar size is typically about 150-200 mW. In some embodiments, the thickness of the E-ink display is approximately 0.4; 0.6; 1.0; 1.25; 1.4; 2.0 μm, etc. As used herein, in the discussion of various embodiments of OLED and E-ink-based displays, approximately means within a tolerance of +0.01%, ±0.1%, ±0.5%, ±2%, ±6%, ±10%, ±15%, ±20%, etc.

The display devices discussed above are often pre-programmed or hard-wired to display only a single preselected message or a set of preselected messages. One reason for this restriction is that a thin, flexible, light weigh, wearable display often lacks significant computing power. For example, they do not include a processor or an application specific integrated circuit (ASIC) customized to perform computations, because processors and ASICs consume power. This would require additional batteries, which would make the overall display system bulkier and/or heavier, which could adversely affect the wearability of the system. As a result, a wearable display is often not used to its fullest potential of selectively displaying different messages at different times, and may be nothing more than an electronic replacement for a message/logo on a patch sewn on to clothing or other articles.

To alleviate this problem, in various embodiments, a flexible display is coupled to a wireless communication interface, such as a wearable low power wireless transceiver. The selection of the messages to displayed can be performed as discussed above at a computer located remotely from the display. The computer may then transmit the selected message(s) (and/or message identifier(s)) directly to the transceiver coupled to the display device and/or via one or more additional intermediate transceivers. The distributed operation performed in this manner can significantly increase the utility of the wearable display by allowing the display of messages selected dynamically, in real time or near real time (e.g., within a few seconds, minutes, or hours after information used to select the message(s) becomes available), without substantially (e.g., more than 5%, 10%, etc.) increasing the size, weight, and/or power consumption of the display device.

In some embodiments, the advertisement/message scheduling and display selection techniques described above with reference to FIGS. 1-3 are not limited to display devices associated with performers and to wearable displays. These techniques can be employed with other objects such as taxis and buses that use conventional displays, and may even be employed with displays affixed in train stations, airports, etc. For example, the rate of advertisement on a taxi can be adjusted based on whether the taxi is located in and/or its distance from a crowded area such as the Times Square, Hollywood Blvd., at an airport, etc., or whether the taxi is located in a relatively remote area. Generally, the advertisement rate would be greater if the taxi is in a crowded area than the rate when the taxi is in a remote are. The rate and/or the selection of advertisements may be based further on whether the taxi is parked or is moving slowly, or whether the taxi is moving fast. An advertisement/message displayed on a slow moving or parked taxi in a crowded area is likely to be viewed by many more viewers relative to a fast-moving taxi or a taxi in a remote area. As such, more advertisements may be scheduled in the former case than in the later. The information about the location of a taxi, a bus (any vehicle, in general) can be obtained from one or more sensors such as the GPS, inertial navigation sensor (INS), etc., associated with the vehicle. The rate and/or the selection of advertisements may also be based on the season and/or weather in which the taxi is operating.

Similarly, an advertisements can be selected and scheduled for display on a display device located at a subway or train station, airport, etc., based on, for example, the train/airline schedule and, optionally, the actual arrival/departure information. For example, a few minutes (e.g., 2, 5, 10 minutes, etc.) before the scheduled or actual departure of a train many more passengers are expected to approach the train platform than those would at other times. Around the boarding time of a plane (e.g., 5, 10, 20, 30, 40 min. etc., before the scheduled or estimated departure time), or during the period (e.g., 5, 10, 20, 30, 40 min. etc.) during which passengers likely await their baggage at the baggage claim, the number of likely viewers is expected to be greater than at other times. Therefore, more message may be scheduled to be displayed on displays located at the train platforms, airline gates, and baggage claim areas, etc., based on scheduled, estimated, and/or actual arrival/departure times.

Additionally or in the alternative, the rates for advertisements can be adjusted during these time periods, as discussed above. In some cases, the advertisements can be selected based on the travel destination, time of the day, day or month of the year, weather, season, etc. For example, in January or February, ski resorts may advertise at baggage claim area displays at the Boston airport, while dinner and whale watching cruises may advertise on those displays during the summer months.

In some embodiments, an advertisement/message can be selected and scheduled for display on a display device located at a subway or train station, airport, etc., or a display device associated with a parked or slowly moving taxi or a bus based on, for example, an estimated crowd size. The crowd size can be determined from one or more images obtained from one or more cameras associated with the display. A number of persons in the image(s) an be computed to estimate the crowd size. In some cases, one or more cameras are affixed to the display or may be placed near (e.g., not more than a foot apart from) the display. In these cases, an eye-ball count of the image(s) obtained using the camera(s) can indicate the number of people looking at the display. Such eye-ball count(s) can be used to estimate the crowd size used for selecting the advertisements/messages, and or rate(s) for the advertisements/messages.

Those skilled in the art will appreciate that the invention may be practiced with various computer system configurations, including hand-held wireless devices such as mobile phones or personal digital assistants (PDAs), multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote computer storage media including memory storage devices.

In some cases, relational (or other structured) databases may provide such functionality, for example as a database management system which stores data related to the services and consumers utilizing the service. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

The computer system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, or another operating system of platform.

At a minimum, the memory includes at least one set of instructions that is either permanently or temporarily stored. The processor executes the instructions that are stored in order to process data. The set of instructions may include various instructions that perform a particular task or tasks. Such a set of instructions for performing a particular task may be characterized as a program, software program, software, engine, module, component, mechanism, or tool.

The system may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript, for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Although internal components of the computer are not shown, those of ordinary skill in the art will appreciate that such components and the interconnections are well known. Accordingly, additional details concerning the internal construction of the computer need not be disclosed in connection with the present invention.

While a generic computer can be used to implement one or more operations performed according to various embodiments, computing a future time period of an on-going event to be allocated to a person with whom the display device is associated requires collecting data from several sources in a short time, e.g., in a few milliseconds, a few seconds, a few minutes, etc. and such data are usually available only in an electronic form. A computer and a communication device are essential to the processing of such data received from different source that are not themselves associated with the display device(s), and for transmitting the messages to remotely located display device(s). Similarly, analyzing events expected with non-moving display(s) affixed in various locations and/or parameters such as location, speed, etc., of movable objects with which display unit(s) are associated, and/or determining an expected viewership of the display device(s), requires using components such as INS, GPS, cameras, and may require specialized image and/or signal processing, for which these additional devices and/or a computer can be essential.

The invention can be embodied in other specific forms without departing from the spirit or essential characteristics thereof. The foregoing embodiments are therefore to be considered in all respects illustrative rather than limiting on the invention described herein.

What is claimed is:

1. A computer-implemented method for selecting a wearable display and a message for display on the selected wearable display, the selected wearable display being affixed to an article associated with a person, the method comprising:
for each person from a plurality of candidate persons obtaining or determining an expected future time period of an on-going event designated to the person based on a level of the person's prior performance during the on-going event, wherein, for each person:
the expected future time period is associated with a value of a quality metric, the value of the quality metric comprising: (i) a length of the expected future time period, or (ii) an expected viewership associated with the expected future time period;
the level is selected from at least a first level and a second level, the second level representing a lower performance than performance associated with the first level; and
the value of the quality metric for the expected future time period corresponding to the first level is greater than the value of the quality metric for the expected future time period corresponding to the second level;
selecting by a processor, based on respective expected future time periods for the plurality of candidate persons, a first person and a first wearable display device associated with the first person;
selecting by the processor, based on the expected future time period for the selected first person, a first message for display on the first wearable display device, the processor being in communication with but located remotely from the first wearable display device; and
wirelessly transmitting during the expected future time period for the first person the first message to the first wearable display device.

2. The method of claim 1, wherein the on-going event comprises a sports tournament.

3. (canceled)

4. The method of claim 1, wherein the expected future time period comprises a broadcast time period during which the person's future performance in the on-going event is to be broadcast.

5-7. (canceled)

8. The method of claim 1, wherein the article is selected from the group consisting of a shirt, a hat, pants, shoes, an arm band, a helmet, a bag, a glove, a racket, a bat, and a stick.

9. The method of claim 1, wherein the first message comprises a first advertisement and the selecting the first advertisement comprises:
computing by the processor, for each of a plurality of candidate advertisements, a corresponding advertisement metric based on at least one parameter of the respective candidate advertisements and the expected future time period; and
designating as the first advertisement the candidate advertisement having a maximum advertisement metric.

10-13. (canceled)

14. The method of claim 1, further comprising downloading the first message to the first wearable display device.

15-17. (canceled)

18. The method of claim 1, wherein the on-going event comprises a show.

19. (canceled)

20. The method of claim 1, wherein the person is one of an athlete, a talent performer, and a contestant.

21-91. (canceled)
